(19) United States
(12) Patent Application Publication
(10) Pub. No.: US 2004/0174544 A1
(43) Pub. Date: Sep. 9, 2004

(54) Arranging images on a page

(76) Inventors: Jack Cassidy, San Diego, CA (US); William Cassidy, San Diego, CA (US)

Correspondence Address: HEWLETT-PACKARD COMPANY, Intellectual Property Administration, P.O. Box 272400, Fort Collins, CO, 80527-2400, US

(21) Appl. No.: 10/620,505

(22) Filed: Jul. 16, 2003

Related U.S. Application Data
(63) Continuation-in-part of application No. 10/378,989, filed on Mar. 3, 2003.

(51) Int. Cl. G06F 15/00; G06F 3/12; G06K 15/02; H04N 1/387

(52) U.S. Cl. 358/1.8; 358/1.12; 358/449; 358/450

(57) ABSTRACT

Arranging digital images. A method embodiment includes generating a first trial and a second trial pack. The packs are generated such that in each trial pack The digital images are uniquely oriented as compared to the other trial pack. The trial packs are compared, and one of the trial packs is selected based on the comparison.

### CROSS REFERENCE TO RELATED APPLICATION

This is a continuation-in-part of application Ser. No. 10/378,989 filed Mar. 3, 2003, and entitled “Arranging Images on a Page.”

### BACKGROUND

Recent advances in digital imaging and printing technologies have enabled the production of high-quality prints of digital images using affordable, commercially available printing devices, for example, fluid ejection printing devices such as ink jet printers. Prints of photo-lab quality may be produced by printing the images onto special types of photo papers that have the textures and appearances of traditional photograph printing papers.

Special photograph printing papers may be quite expensive in comparison to ordinary printing paper. Therefore, to lower the cost of printing images on such papers, multiple images may be printed onto a single page. However, typical printing software programs do not attempt to arrange the images on a page in such a manner as to use the available space on the page in an efficient manner. Instead, these programs merely check whether an image will fit on a currently used page in an orientation specified by the user. If the image does not fit, it is put on a new page. Such printing methods may result in the inefficient use of expensive printing papers.

Various publishing software programs exist that allow a user to place images on a page in desired locations before printing the page. However, because the user typically places each individual image onto a page with these programs, the arrangement of images on the page may be a time-consuming and inefficient process. Furthermore, where printing a large number of images of a plurality of different sizes, it may be difficult for the user to determine whether earlier-filled pages have leftover space into which later images may be fit.

Other publishing programs have the capability to arrange images onto a page automatically. However, these programs typically arrange the photos in such a way as to make the page resemble a page from a photo album. The images are thus arranged to make the page as a whole appear aesthetically pleasing, rather than to increase the efficient utilization of page space.

### DESCRIPTION OF THE DRAWINGS

FIG. 1 illustrates an exemplary network environment in which embodiments of the present invention can be implemented.

FIGS. 2A-2C are block diagrams showing some of the programs running on the computer of FIG. 1 according to various embodiments of the present invention.

FIG. 3 is a block diagram illustrating logical program elements of a packing module according to an embodiment of the present invention.

FIG. 4 is an exemplary screen view of a user interface used to direct the printing of one or more images according to an embodiment of the present invention.

FIG. 5 is an exemplary flow diagram illustrating steps for arranging digital images on a page according to an embodiment of the present invention.

FIG. 6 is an exemplary flow diagram expanding on the step of generating trial packs of FIG. 5 according to an embodiment of the present invention.

FIGS. 7 is an exemplary flow diagram expanding on the steps of opening and continuing a trial pack of FIG. 6 according to an embodiment of the present invention.

FIGS. 8 illustrates an exemplary set of digital images having varying sizes.

FIGS. 9-16 are exemplary sequential plan views of a page as trial packs are formed for the set of digital images of FIG. 8 according to an embodiment of the present invention

FIG. 17 is an exemplary table used to illustrate packing data for trial packs generated using the digital images of FIG. 8 according to an embodiment of the present invention.

FIG. 18 is an exemplary flow diagram illustrating steps taken to define packing areas according to an embodiment of the present invention.

FIG. 19 illustrates an exemplary set of digital images having varying sizes.

FIGS. 20-24 are exemplary sequential plan views of a page and help to illustrate packing areas being defined as a particular trial pack is generated using the digital images of FIG. 19.

### DETAILED DESCRIPTION

INTRODUCTION: Through a user interface, users are able to identify one or more digital images, the number of copies of each digital image to be printed, and the print size of each copy. Various embodiments of the present invention function to help orient and pack the selected digital images so that fewer pages are required. To do so a number of trial packs are generated. A trial pack is an attempt at arranging each of the digital images on a single page. Depending upon the number and sizes of the identified digital images, in many cases a given trial pack will not fit all of the identified digital images on a single page. In such cases, a particular trial pack will not use all of the identified digital images. In each given trial pack, at least some of the digital images are uniquely oriented and/or positioned as compared to the other trial packs. As between two given trial packs, some of the digital images may share the same orientation and/or position but not all of the digital images. Once generated, the trial packs are compared, and the trial pack that most efficiently uses page space is selected.

As used in the following description and claims an image can be either digital or printed. A digital image is made up of a grid of pixels selected and arranged to reveal any combination of text and/or graphics. A digital image can be one of or incorporated within any number of formats. Format examples include, but are in no means limited to, PDL (page description format), PDF (Portable Document Format), bitmap, TIFF (Tagged Image File Format), and JPEG (Joint Photographic Experts Group). A printed image is a physical rendition of a digital image. A digital image may be printed on paper, plastic, fabric, or any other suitable print media.

Similarly, a page can either be digital or physical. In a physical form, a page is any a medium, without regard to shape, on which one or more digital images can be printed. For example, a t-shirt can be a page. A sheet of paper can be a page. In digital form, a page is an electronic canvas on which digital images can be arranged before being printed.

The description that follows is broken into sections. The first section, labeled “components” describes exemplary logical and physical elements used to implement various embodiments of the present invention. The next section, labeled “operation,” describes exemplary steps taken to practice various embodiments of the present invention.

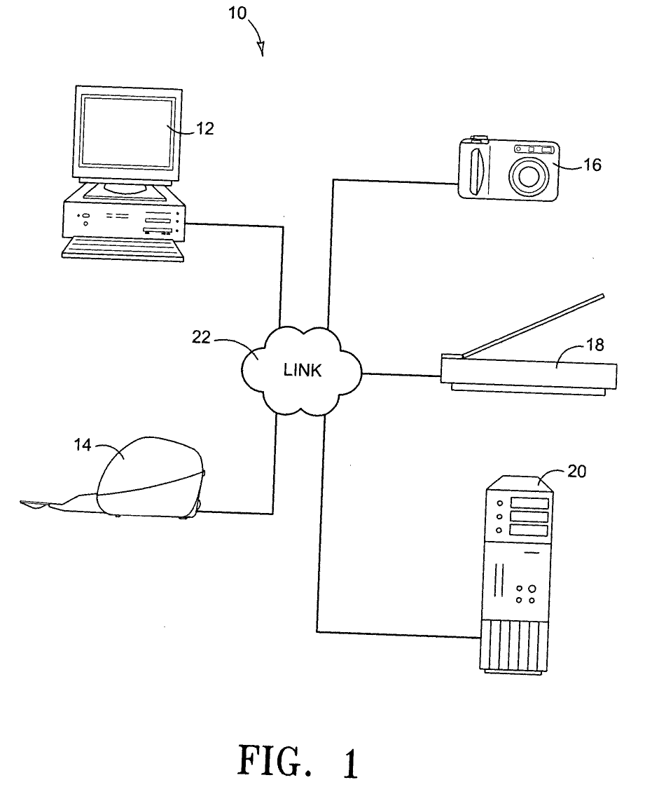

COMPONENTS: FIG. 1 illustrates an exemplary computing environment 10 in which various embodiments of the present invention may be implemented. Environment 10 includes, computer 12, image forming device 14, digital camera 16, scanner 18, and remote image source 20. Computer 12 represents generally any computing device capable of directing image forming device 14 to print one or more digital images. For example, computer 12 may be a desktop computer, a laptop computer, a PDA (Personal Digital Assistant) or any other device capable of issuing printing instructions to image forming device 14.

Image forming device 14 represents generally any device capable of forming printed images on one or more pages as instructed by computing device 12. For example, image forming device 14 may be a conventional laser or ink printer. Image forming device 14 may but need not perform functions related or unrelated to printing.

Digital camera 16 represents any camera capable of capturing images digitally rather than on film. Scanner 18 represents generally any device capable of digitally capturing a printed image. Once a digital image has been captured, it can be transferred to computer 12, it can be manipulated with a graphics program, and it can be printed. Remote image source 20 represents generally any device capable of supplying digital images to computer 12. For example, remote image source 20 may host a web site or web service from which computer 12 can download or otherwise access digital images.

Link 22 represents generally a cable, wireless, or remote connection via a telecommunication link, an infrared link, a radio frequency link, or any other connector or system of connectors that provide electronic communication between computer 12 and the other components 14-20 of environment 10. Link 22 may include an intranet, the Internet, or a combination of both. Each portion of link 22 connecting a given component 14-20 to computer 12 may or may not be distinct from the remaining portions of link 22. For example image forming device 14 may be connected to computer 12 via a parallel connection, digital camera 16 and scanner 18 may be connected via a USB (universal Serial Bus) connection, and remote image source 20 may be connected via the Internet.

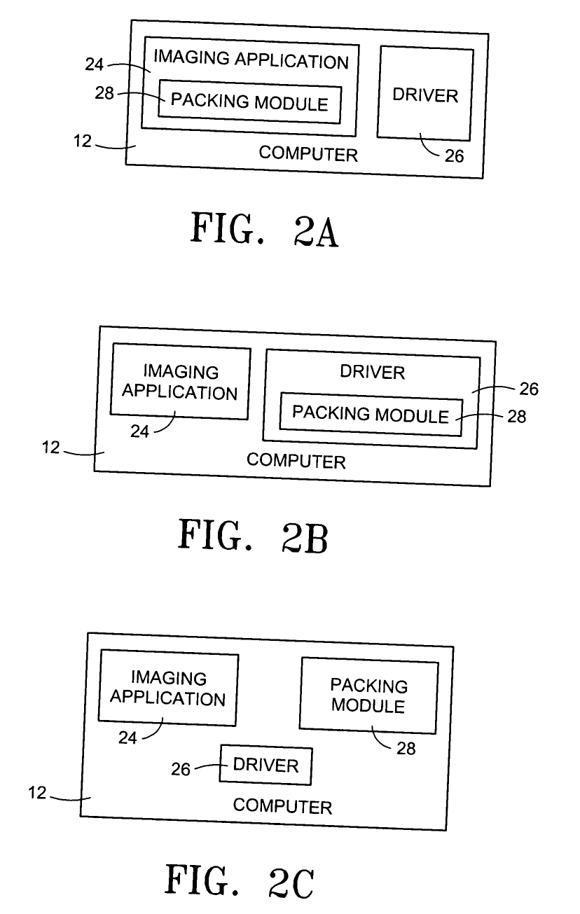

FIGS. 2A-2C are exemplary block diagrams showing some of the programs running on the computer of FIG. 1. In each of FIGS. 2A-2C, computer 12 includes imaging application 24 and driver 26. Imaging application 24 represents generally any program capable of directing that one or more digital images be printed. Imaging application 24 may also be capable of creating and/or manipulating digital images. Driver 26 is a program responsible for translating generic printing instructions received from imaging application 26 into device specific instructions capable of being processed by image forming device 14.

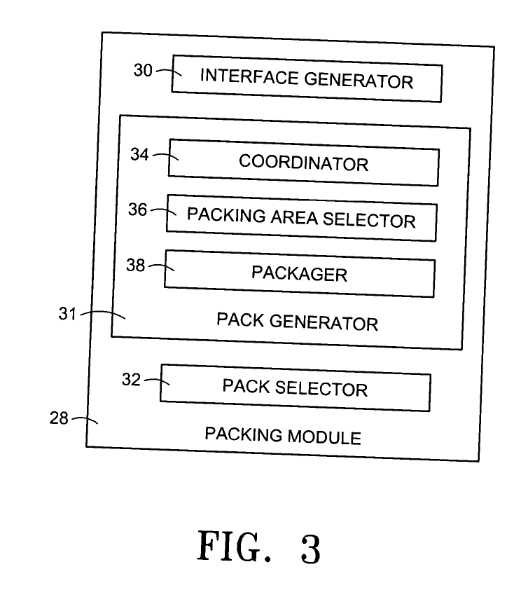

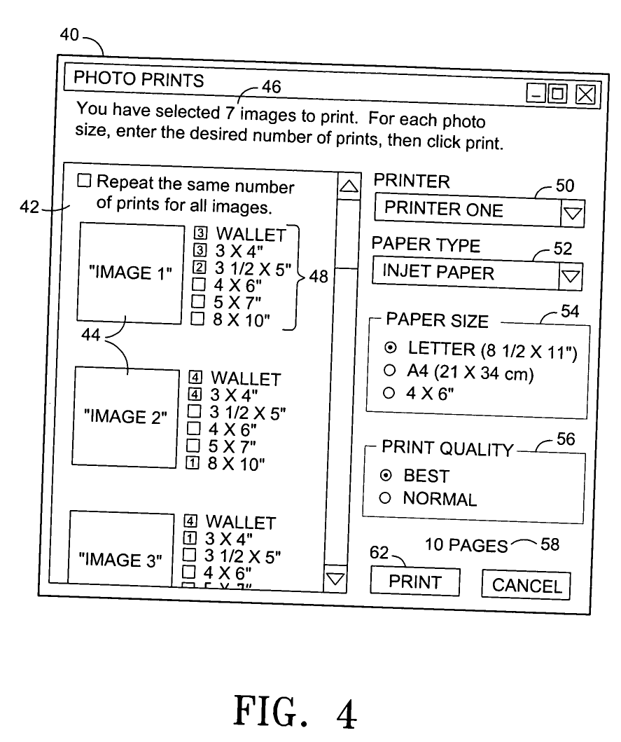

As shown in FIGS. 2A-2C, computer 12 also includes packing module 28. Described in more detail below with reference to FIG. 3, packing module 28 represents generally a program capable of identifying the number and size of one or more digital images to be printed. Using the identified digital images, packing module 28 generates, if possible, a number of trial packs. Packing module 28 compares the generated trial packs and then selects the trial pack that most efficiently uses page space. Where a selected trial pack does not use all of the identified digital images, the process repeats, and packing module 28 generates a number of new trial packs for the unused digital images. The new trial packs are compared and packing module 28 again selects the trial pack that most efficiently uses page space. The process keeps repeating until all of the identified digital images have been used by one or more selected trial packs.

In the end, each trial pack selected by packing module 28 represents the layout of a page to be printed. Ultimately, the number and sizes of the identified digital images will determine the total number of pages required. The goal for packing module 28 is to reduce and hopefully minimize the total number of number of pages required. Once a particular trial pack is selected, a page containing the digital images used by that trial pack can be printed.

In FIG. 2A, packing module 28 is part of imaging application 24. In FIG. 2B, packing module 28 is part of driver 26. In FIG. 2C, packing module 28 is a separate from imaging application 24 and driver 26. While not shown, packing module 28 may also be a component of an operating system for computer 12.

Referring now to FIG. 3, packing module 28 includes interface generator 30, pack generator 31, and pack selector 32. Interface generator 30 represents generally any program capable of presenting an interface for selecting digital images to be printed. Where the presented interface is a user interface, it may contain one or more user accessible controls for selecting or otherwise identifying digital images. The presented interface may also be a programmatic interface that allows another program to select or otherwise identify digital images.

Pack generator 31 represents generally any program capable of generating trial packs for a selected set of digital images. Pack generator 31, in the example shown, includes coordinator 34, packing area selector 36, and packager 38. Coordinator 34 represents a program capable of managing the order in which selected digital images are used in a trial pack. Coordinator 34 is responsible for identifying or noting each discrete size shared by one or more of the selected digital images and the number of digital images that share each discrete size. Coordinator 34 is responsible for identifying the remaining digital images with the largest discrete size that will fit in a packing area. Coordinator 34 also keeps track of those digital images that have not been used in a particular trial pack.

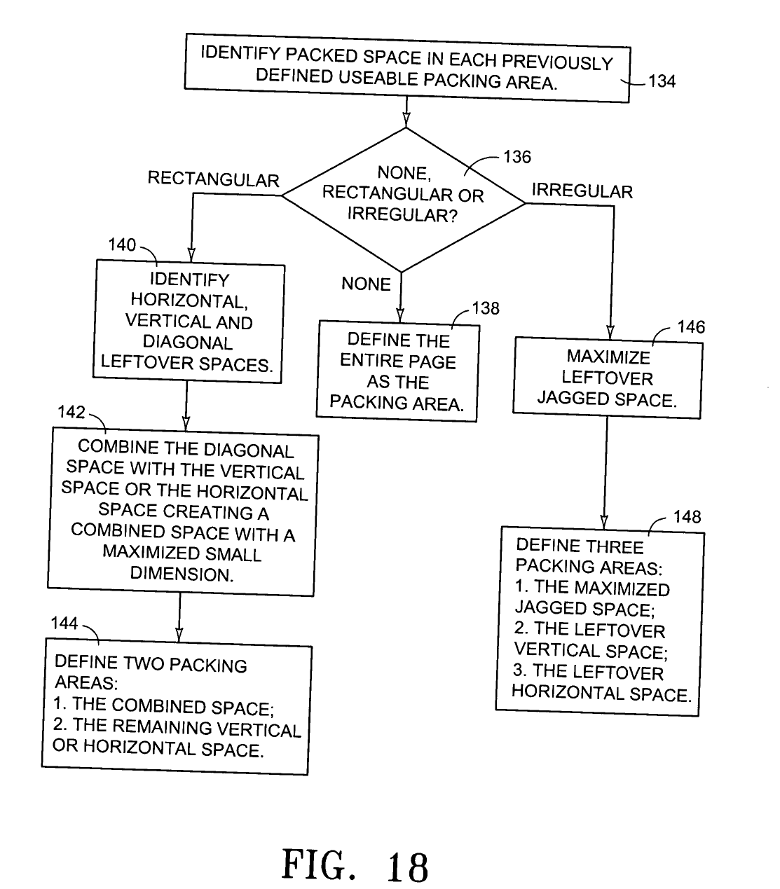

Packing area selector 36 represents a program responsible for defining packing areas. A packing area is an area on a page not used by a given trial pack. FIG. 18, described below, illustrates steps that may be taken by packing area selector 36 to define packing areas.

Packager 38 represents a program capable of orienting and packing digital images in a defined packing area and of maintaining packing data. Packing data is information used to represent a particular trial pack. Packing data, for example, can include information such as the number of digital images used in the trial pack, an identification of the digital images not used, information identifying the page placement and orientation for each digital image used, and/or information concerning the amount of unused space remaining on the page.

As an example, packager 38 opens a trial pack as an empty page—the entire page being defined by packing area selector 36 as a packing area. For digital images that have yet to be used in a particular trial pack, coordinator 34 identifies the largest remaining discrete size that will fit in a defined packing area. Packager 38 determines if a digital image of the identified size will fit in at a first orientation and in a second orientation. A digital image can be oriented in any number of positions. A rectangular digital image, for example, is commonly placed in either a landscape or a portrait orientation, the difference being a rotation of about ninety degrees. However, in one orientation, a digital image may be rotated more or less than ninety degrees relative to another orientation. A digital image with a particular orientation has known dimensions, and a defined packing area has known dimensions. Packager 38 can compare the dimensions of the two and determine if the digital image will fit in the defined packing area.

If determined to fit, packager 38 packs as many digital images of the identified size as possible in the first orientation. This represents one trial pack. If determined to fit, packager 38, then, starts over and packs as many digital images of the identified size as possible in the second orientation. This represents a second trial pack. The number of digital images of a given size that can be packed in a packing area is limited by at least two factors—the size of the packing area and the number of digital images of the given size. For example, where there is only one remaining digital image of the identified size, it is only possible to pack that one digital image. Where there are two remaining digital images of the identified size, but the packing area is only large enough to hold one, it is only possible to pack one digital image.

For each trial pack, the packager 38 repeats the process, potentially continuing the trial pack with two trial packs. When it is determined that no remaining size will fit in any available orientation in any defined packing area, packager 38 closes the particular trial pack. No attempts are made to continue closed trial packs. In other words a closed trial pack is one that cannot be continued because no more digital images from a set can be used by that trial pack.

Packager 38 is also responsible for maintaining packing data for each trial pack. As will be described below, initially two trial packs are attempted. Packager 38 creates packing data for each. Each of those trial packs may then be continued if it will hold at least one more digital image. A trial pack that can be continued is referred to a parent. A trial pack continued from a parent is referred to as a child. To create packing data for a child, packager 38 updates the packing data for the parent to include information relating to the additional digital image or images packed in the child.

Pack selector 32 represents a program capable of comparing closed trial packs generated by pack generator 31 and selecting a particular trial pack based upon the comparison. The act of comparing closed trial packs includes comparing packing data for each of the trial packs. For example, pack selector 32 could compare packing data for each closed trial packs to identify the trial pack that left the least unused space.

In many cases, not all of the selected digital images will be used in a trial pack selected by pack selector 32. Pack selector 32 then selects the unused digital images as the set of digital images and instructs pack generator 31 to generate new trial packs for the redefined set of digital images. This continues until all of the digital images from a set are used in a trial pack selected by pack selector 32.

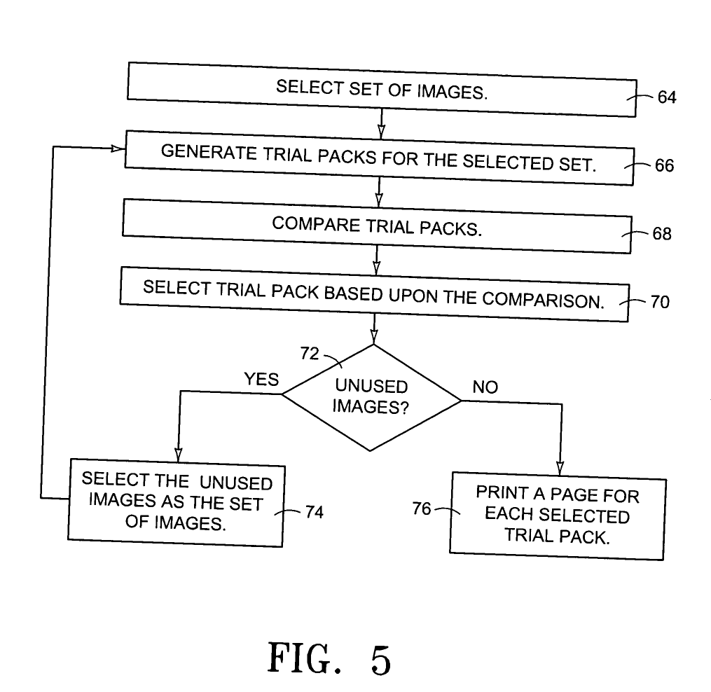

FIG. 4 is an exemplary screen view of user interface 40 for selecting digital images to be printed. It is noted that digital images selected for printing can include multiple copies of the same digital image. User interface 40 includes a photo display field 42 that shows a thumbnail-sized, or otherwise reduced size, rendition of each digital image 44 identified for printing. A caption 46 at the top of user interface 40 may be used to indicate how many digital images the user has selected for printing. Where more digital images are selected than are displayable within photo display field 42, a scroll bar may be supplied to allow a user to scroll other digital images into the photo display field.

Next to each digital image 44, a print size and quantity field 48 may be provided that allows the user to select the quantity and size of each digital image 44 to be printed. For example, in the depicted embodiment, three wallet-sized prints, three 3×4″ prints, and two 3½×5″ prints are to be printed for IMAGE 1. Likewise, four wallet-sized prints, four 3×4″ prints, and one 8×10″ print are to be printed for IMAGE 2. Four wallet-sized and one 3×4″ print are to be printed for IMAGE 3. While only three digital images 44 are identified in field 42, twenty-two digital images have been selected. —eight prints of IMAGE 1, nine prints of IMAGE 2, and five prints of IMAGE 3.

User interface 30 also may include a printer selection field 50, a paper type field 52, a paper size field 54, a print quality field 56, and a total pages field 58. Printer selection field 50 allows the user to specify a desired image forming device, where multiple printing devices are available. Paper type field 52 allows the user to select what type of paper the digital image is being printed on so that a correct mixture of printing fluids may be used for each supported paper type for accurate color reproduction and optimum appearance. Paper size field 54 allows the user to select a desired size of paper for printing, and print quality field 56 allows a user to select print quality in order to preserve printing material (e.g., ink fluids, dry toner, etc) where a print of the highest quality is not required.

The total number of pages needed for printing may then be calculated and displayed in total pages field 58 so that the user may ensure sufficient paper is loaded in the selected printing device. Total pages field 58 may be updated with every change in the number of prints requested so that the total number of pages displayed in the field is always up-to-date.

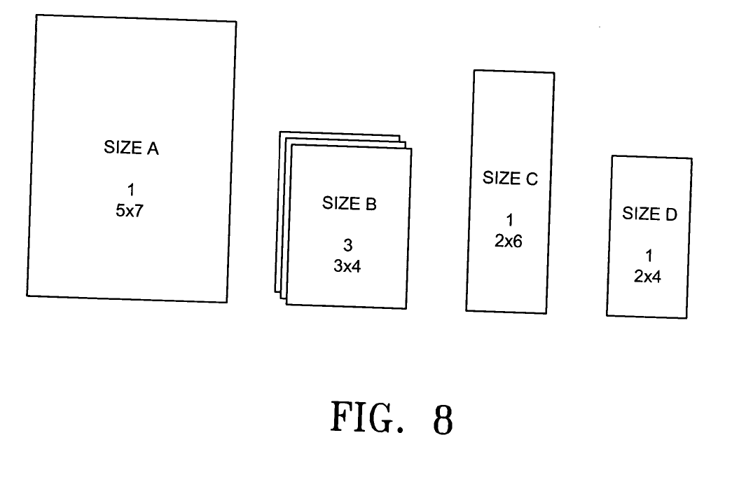

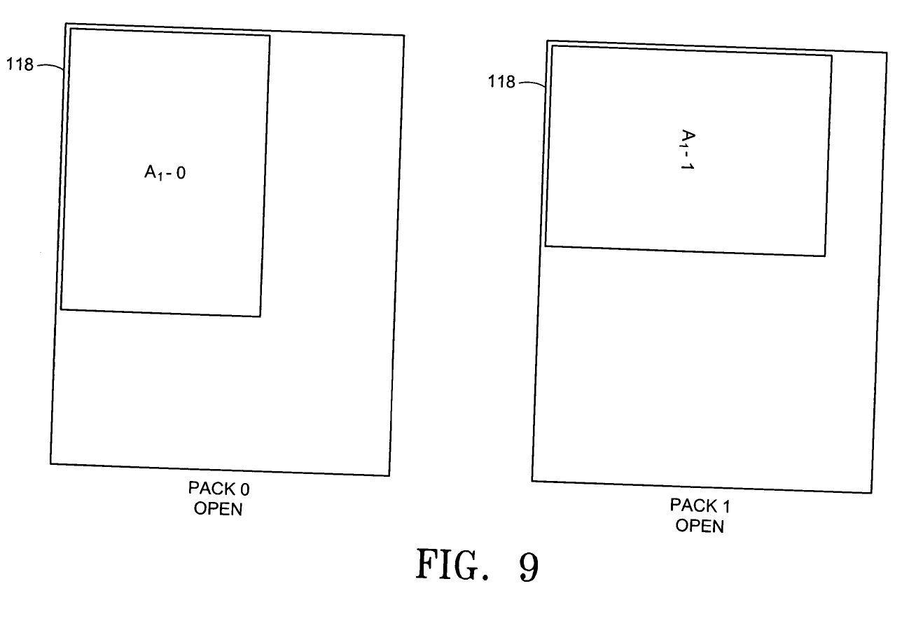

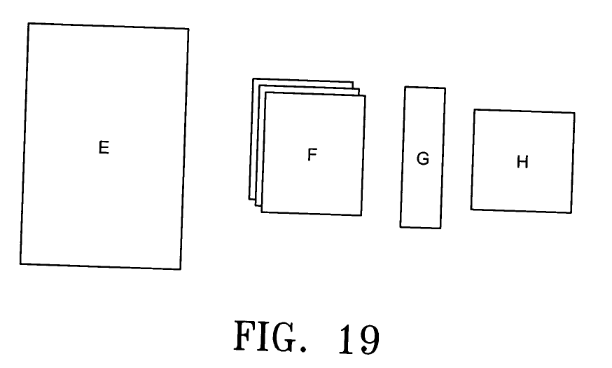

OPERATION: The operation of embodiments of the present invention will now be described with reference to FIGS. 5-24. FIGS. 5-7 and 18 are exemplary flow diagrams that help illustrate steps taken to generate trial packs from a set of selected digital images and to select a particular trial pack for printing. FIG. 8 illustrates an exemplary set of digital images. FIGS. 9-16 sequentially illustrate a page as trial packs are generated using the digital images of FIG. 8. FIG. 17 is a table used to help illustrate packing data for trial packs generated using the digital images of FIG. 8. Fig, 18 illustrates another exemplary set of digital images. FIGS. 19-24 sequentially illustrate a page as packing areas are defined as a trial pack is generated using the digital images of FIG. 18.

Starting with FIG. 5, a set of digital images is selected for printing (step 64). This can be accomplished, for example, through an interface presented by interface generator 30 (FIG. 3). Trial packs are generated for the selected digital images (step 66). Step 66 can be accomplished by pack generator 31 (FIG. 3). Once generated, the trial packs are compared (step 68). One trial pack is then selected based upon that comparison (step 70). For example, the trial pack that leaves the least unused space might be chosen. Steps 68 and 70 can be accomplished by pack selector 38 (FIG. 3). It is next determined if any digital images from the selected set have not been used in the trial pack selected in step 70 (step 72). Any unused digital images are selected as the set (step 74) and the process repeats with step 66 where trial packs are generated for the redefined set of unused digital images. Otherwise, a page can be printed for each trial pack that has been selected (76).

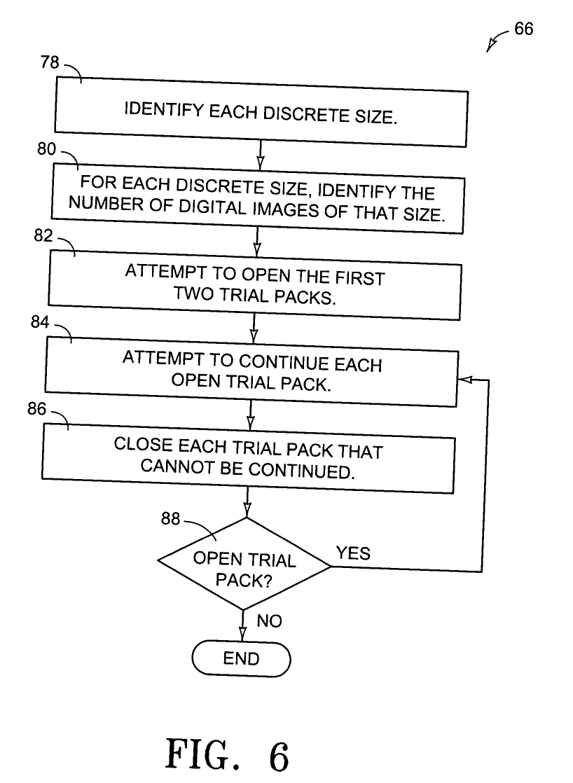

The flow diagram of FIG. 6 helps to illustrate steps taken to generate trial packs—step 66 of FIG. 5. Each discrete size of a selected set of digital images is identified (step 78). For each discrete size, the number of digital images sharing that size are identified (step 80). For example, a set may include an eight by ten, three five by sevens, and six wallet sized digital images. Step 78 would then involve noting the three discrete sizes, and step 80 would involve noting the number of each size.

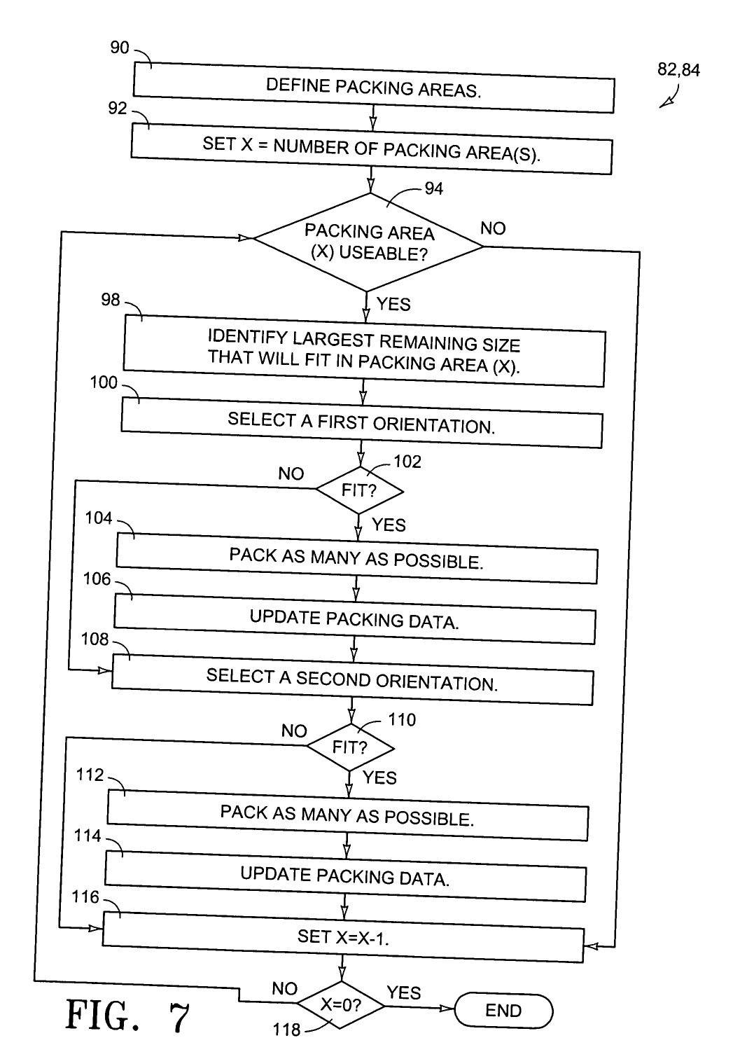

Attempts are made to open the first two trial packs (step 82). For each open trial pack, an attempt is made to continue that trial pack (step 84). Steps 82 and 84 are described in more detail with reference to FIG. 7. Each trial pack that cannot be continued is closed (step 86). A trial pack that cannot be continued is one in which no more remaining digital images will fit in any available orientation in any remaining packing area. A trial pack that has not been closed is considered to be open. It is determined if an open trial pack remains (step 88). If one or more trial packs are still open, the process repeats with step 84. Otherwise, the process ends. Referring back to FIG. 5, each of the closed trial packs are compared in step 68, and one is selected in step 70.

FIG. 7 helps to further illustrate steps taken to open and continue trial packs—steps 82 and 84 of FIG. 6. Initially, packing areas are defined (step 90) Where FIG. 7 is an expansion of step 84 from FIG. 6, step 90 involves defining two or more packing areas. Where FIG. 7 is an expansion of step 82 from FIG. 6, step 90 simply involves defining an entire page as a packing area. Step 90 will be discussed in more detail with reference to FIG. 18-24 below.

The variable X is set to equal the number of packing areas defined in step 90 (step 92). Where, for example, N packing areas are defined in step 90, each packing area can be identified by a number—one identifying the smallest packing area and N identifying the largest. It is next determined if packing area (X) is useable (Step 94). A useable packing area is one in which a size of a remaining digital image will fit in any available orientation. This size is a discrete size (identified in step 78 of FIG. 6) of a digital image that has not been used in the particular trial pack. That digital image, however, may have been used in another trial pack. If no remaining digital image will fit, packing area (X) is not useable and the process skips to step 116. If packing area (X) is useable, the largest size of a remaining digital image that will fit in packing area (X) is identified (step 98).

Where FIG. 7 is an expansion of step 82 of FIG. 6, the remaining steps 100-117 illustrate steps taken in an attempt to start the first two trial packs. The attempt may be successful or partially successful with only one trial pack being opened. Where FIG. 7 is an expansion of step 84 of FIG. 6, steps 100-117 are steps taken in an attempt to continue a parent trial pack with two child trial packs. The attempt may be successful or partially successful with the parent trial pack continuing with only one child trial pack. Using one or more digital images of the size identified in step 98, steps 100-106 involve attempting to start a first pack or continue a parent trial pack with a first child trial pack. Steps 108-114 involve attempting to start a second trial pack or to continue a parent trial pack in second child trial pack.

Starting with steps 100-106, a first orientation is selected (step 100). It is determined if a digital image of the size identified in step 98 will fit in packing area (X) in the first orientation (step 102). If none will fit, the process jumps to step 108. If one will fit, as many images as possible of the identified size are packed in the first orientation (step 104). For example, where there is only one remaining digital image of the identified size, it is only possible to pack that one digital image. Where there are two remaining digital images of the identified size, but the packing area is only large enough to hold one, it is only possible to pack one digital image.

Packing data is then updated (step 106). Where FIG. 7 is an expansion of step 84 of FIG. 6, step 106 involves updating parent packing data to include information regarding orientation and placement the digital image or images packed in step 104. Where FIG. 7 is an expansion of step 82 of FIG. 6, no parent packing data exists, so step 106 involves creating packing data that includes information regarding the orientation and placement of the digital images packed in step 104. At this point, either a new trial pack has been started or a parent trial pack has been continued with a child trial pack.

Moving on to steps 108-114, a second orientation is selected and a packing area is defined (step 108). It is determined if a digital image of the size identified in step 98 will fit in the packing area in the second orientation (step 110). If none will fit, the process jumps to step 116. If one will fit, as many images as possible of the identified size are packed in the second orientation (step 112). Packing data is then updated (step 114). Where FIG. 7 is an expansion of step 84 of FIG. 6, step 108 involves updating parent packing data to include information regarding the orientation and placement of the digital image or images packed in step 112. Where FIG. 7 is an expansion of step 82 of FIG. 6, no parent packing data exists, so step 114 involves creating packing data that includes information regarding the orientation and placement of the digital images packed in step 112. At this point, either a new trial pack has been started or a parent trial pack has been continued with a child trial pack, and the process continues with step 116.

It is noted that steps 108-114 are distinct from steps 100-106 in that the packing data updated in step 114 does not contain information regarding the orientation and placement of the digital images packed in step 104. Packing data updated in step 106 is a reflection of one trial pack while packing data updated in step 114 reflects a different trial pack.

Following steps 100-114, packing area (X) has been used. The value of variable X is then decreased by one (step 116). It is determined if the variable X now equals zero (step 117), indicating that all useable packing areas defined in step 90 have been used. Where, the answer to step 117 is no the process repeats starting with step 98. Otherwise, the useable packing areas have been depleted, and the process ends.

Referring now to FIG. 8, a set of six digital images of four discrete sizes A-D are shown. FIGS. 9-16 illustrate a progression as trial packs are generated using the digital images of FIG. 8. Starting with FIG. 9, two trial packs have been successfully opened. In the following discussion each digital image is identified by size and number. For example the second digital image of size B is identified as B₂ In the first trial pack, PACK 0, digital image A₁ has been placed in a zero (portrait) orientation on page 118. In the second, PACK 1, digital image A₁ has been placed in a one (landscape) orientation on page 118. It is noted that another digital image of size A would not fit in PACK 0. However, one would fit in PACK 1, but there is only one digital image of size A, so it is not possible to pack any more digital images of size A in PACK 0 or in PACK 1. PACK 0 and PACK 1 remain open because images of other sizes will still fit in each.

FIG. 10 illustrates PACK 0 successfully continued and split into PACK 0.0 and PACK 0.1. In PACK 0.0, digital images B₁ and B₂ have each been packed in a zero orientation on page 118. Once digital images B₁ and B₂ are placed, there is no more room for digital image B₃ in a zero orientation. However room remains for at least one remaining digital image so PACK 0.0 remains open. In PACK 0.1, digital images B₁ and B₂ have each been packed in a one orientation on page 118. Once digital images B₁ and B₂ are placed, there is no more room for digital image B₃ in a one orientation. However room remains for at least one remaining digital image so PACK 0.1 remains open.

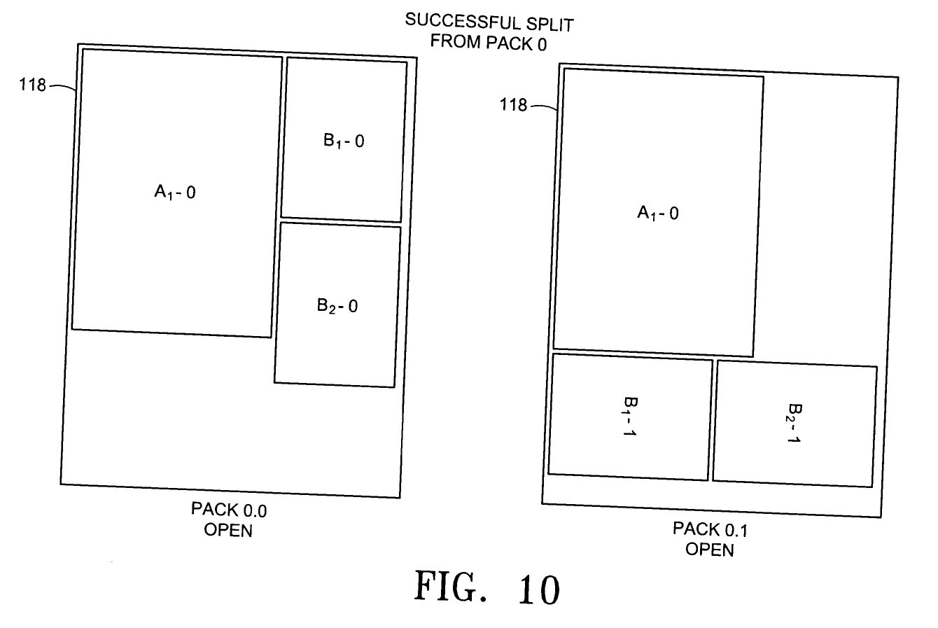

FIG. 11 illustrates PACK 1 (FIG. 9) successfully continued and split into PACK 1.0 and PACK 1.1. In PACK 1.0, digital images B₁ and B₂ have each been packed in a zero orientation on page 118. Once digital images B₁ and B₂ are placed, there is no more room for digital image B₃ in a zero orientation. However room remains for at least one remaining digital image so PACK 1.0 remains open. In PACK 1.1, digital images B₁ and B₂ have each been packed in a one orientation on page 118. Once digital images B₁ and B₂ are placed, there is no more room for digital image B₃ in a one orientation. However room remains for at least one remaining digital image so PACK 1.1 remains open.

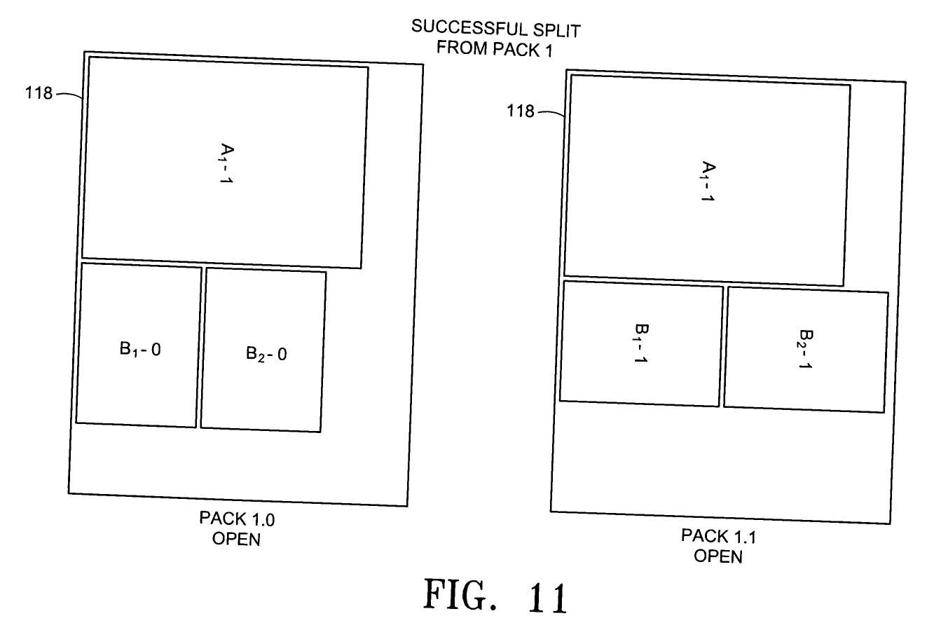

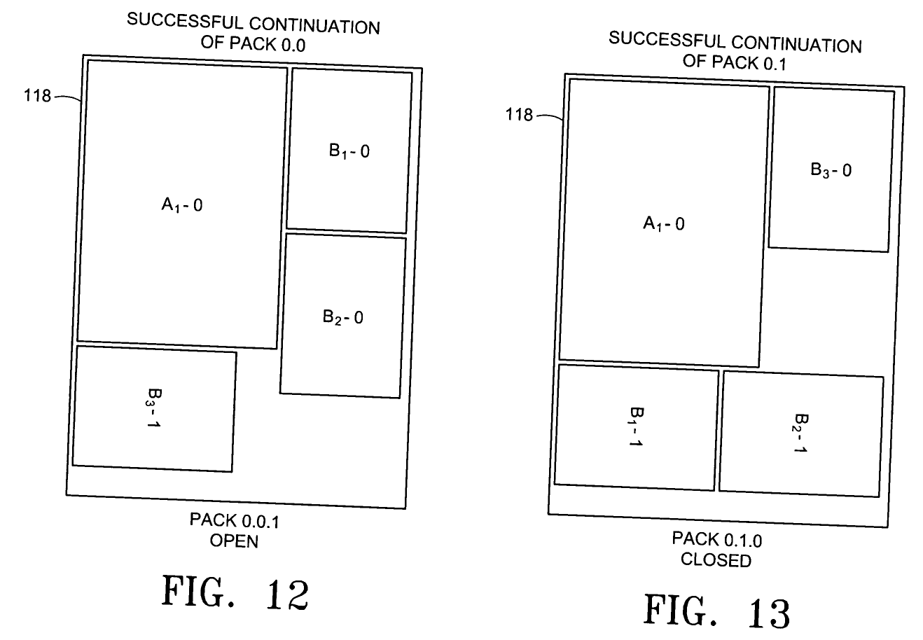

FIG. 12 illustrates PACK 0.0.1 successfully continued from PACK 0.0 (FIG. 10. Digital image B₃ has been packed in a one orientation on page 118. Digital image B₃ would not have fit in a zero orientation, so PACK 0.0 could not be split into two. Room remains, however, for at least one remaining digital image, so PACK 0.0.1 remains open.

FIG. 13 illustrates PACK 0.1 (FIG. 10) successfully continued in PACK 0.1.0 in which digital image B₃ has been packed in a one orientation on page 118. With digital image B₃ packed, there is not room on page 118 for even the smallest remaining digital image, so PACK 0.1.0 is closed. Digital image B₃ would not have fit in a one orientation, so PACK 0.1 could not be split into two.

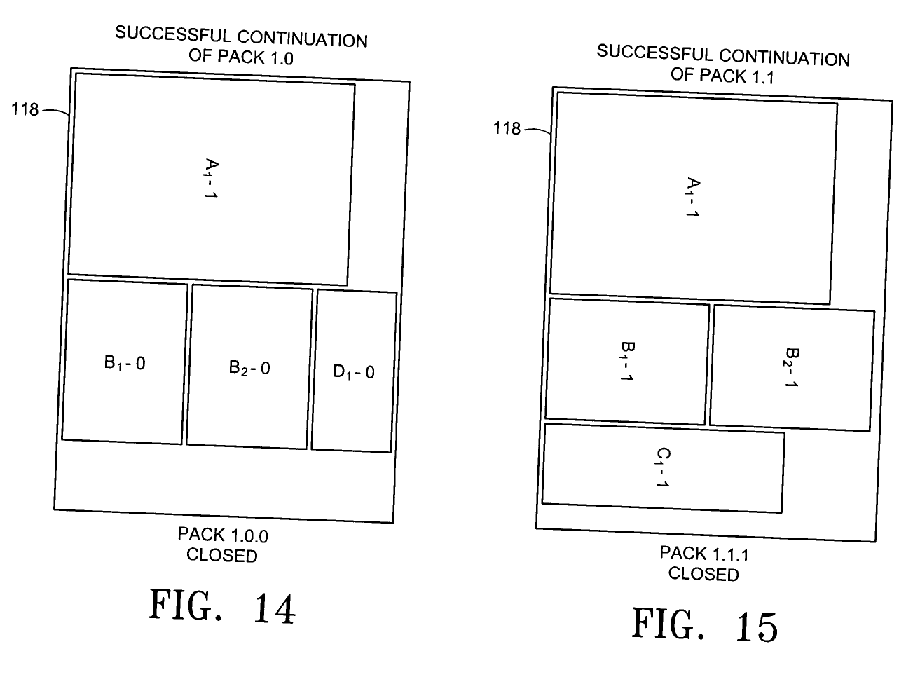

FIG. 14 illustrates PACK 1.0 (FIG. 11) successfully continued in PACK 1.0.0 in which digital image D₁ has been packed in a zero orientation on page 118. Once digital images B₁ and B₂ were packed in PACK 1.0, no room remained for digital images B₃ or C₁ in either orientation. Digital image D₁ was selected as the largest remaining digital image. With digital image D₁ packed, there is not room on page 118 for even the smallest remaining digital image, so PACK 1.0.0 is closed. Digital image D₁ would not have fit in a one orientation, so PACK 1.0 could not be split into two.

FIG. 15 illustrates PACK 1.1 (FIG. 11) successfully continued in PACK 1.1.1 in which digital image D₁ has been packed in a zero orientation on page 118. Once digital images B₁ and B₂ were packed in PACK 1.1, no room remained for digital images B₃ in either orientation. Digital image C₁ was selected as the largest remaining digital image. With digital image C₁ packed, there is not room on page 118 for even the smallest remaining digital image, so PACK 1.1.1 is closed. Digital image C₁ would not have fit in a zero orientation, so PACK 1.1 could not be split into two.

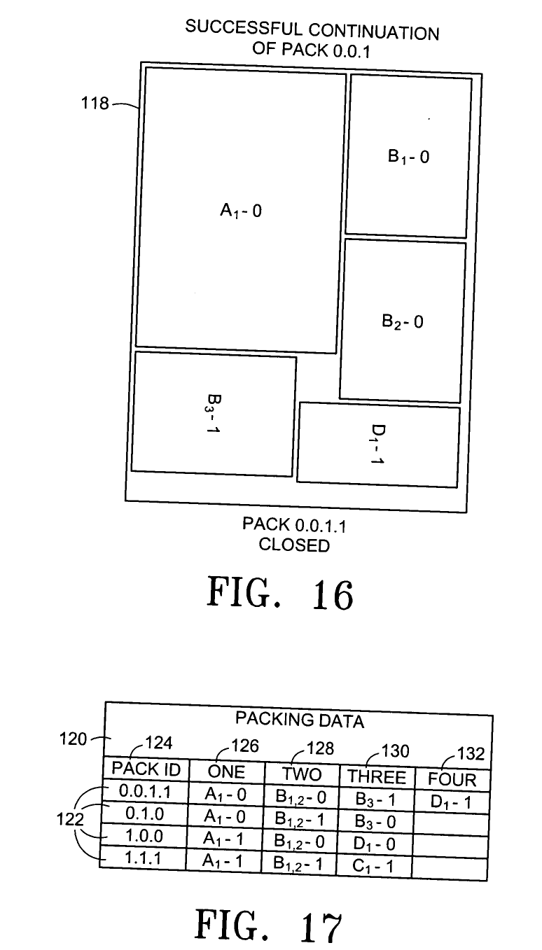

FIG. 16 illustrates PACK 0.0.1.1 successfully continued from PACK 0.0.1 (FIG. 12). Digital image D₁ has been packed in a one orientation on page 118. Once digital image B₃ was packed in PACK 0.0.1, no room remained for digital image C₁ in either orientation. Digital image D₁ was selected as the largest remaining digital image. With digital image D₁ packed, there is not room on page 118 for even the smallest remaining digital image, so PACK 0.0.1.1 is closed. Digital image D₁ would not have fit in a zero orientation, so PACK 0.0.1 could not be split into two.

At this point four trial packs have been generated and closed—PACK 0.0.1.1 (FIG. 16), PACK 0.1.0 (FIG. 13), PACK 1.0.0 (FIG. 14), and PACK 1.1.1 (FIG. 15). No trial packs remain open, so all possible trial packs have been generated for the digital images shown in FIG. 8. Comparing the four closed trial packs, PACK 0.0.1.1 might be selected because it leaves the least unused space.

FIG. 17 illustrates table 120 with entries 122 that each represent packing data for a closed trial pack. Each entry 122 includes a pack identifier field 124 and one or more level data fields 126-132. As shown in table 12, each level data field 126-132 of a given entry 122 contains data identifying a digital image or digital images and an orientation. For example B1,2-0 indicates that digital images 1 and 2 of size B are packed in a zero orientation. While not shown each level data field 126-132 may also contain data representing the page placement for each identified digital image. Each entry 122 may also include a field, not shown, containing data identifying the amount of unused space left after each of the digital images identified in fields 126-132 are packed.

FIG. 18 is an exemplary flow diagram illustrating steps taken to define one or more packing areas. As an example, FIGS. 19-24 illustrate an implementation of the steps 134-148 of FIG. 18. FIG. 19 illustrates an exemplary set of digital images. FIGS. 20-24 sequentially illustrate a page as packing areas are defined while a trial pack is being generated.

Starting with FIG. 18, packed space is identified in each previously defined useable packing area (step 134). Packed space is space on a page that has been packed with other digital images in a given trial pack. Steps 136-148 are repeated for each previously defined packing area.

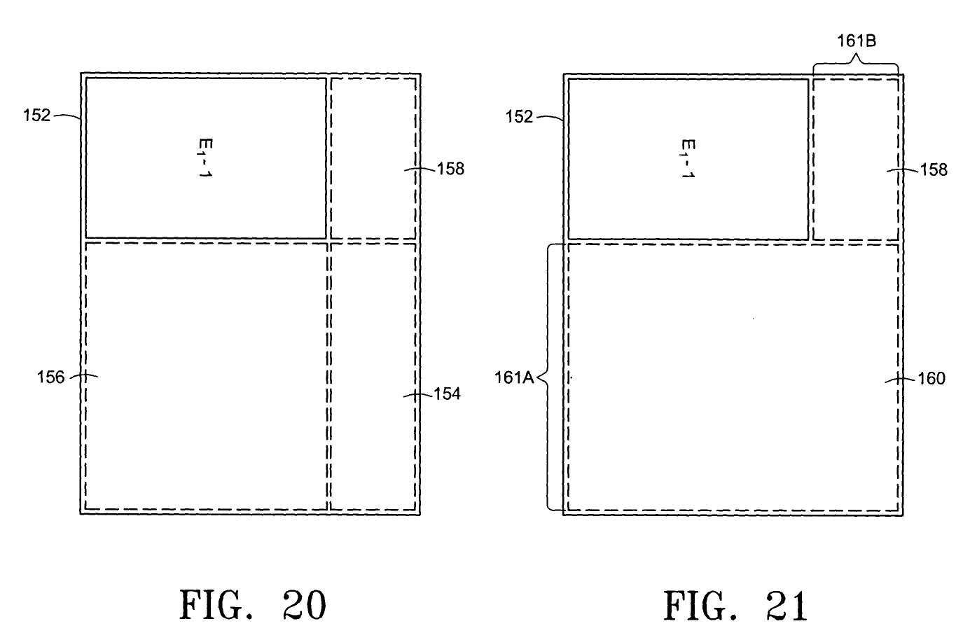

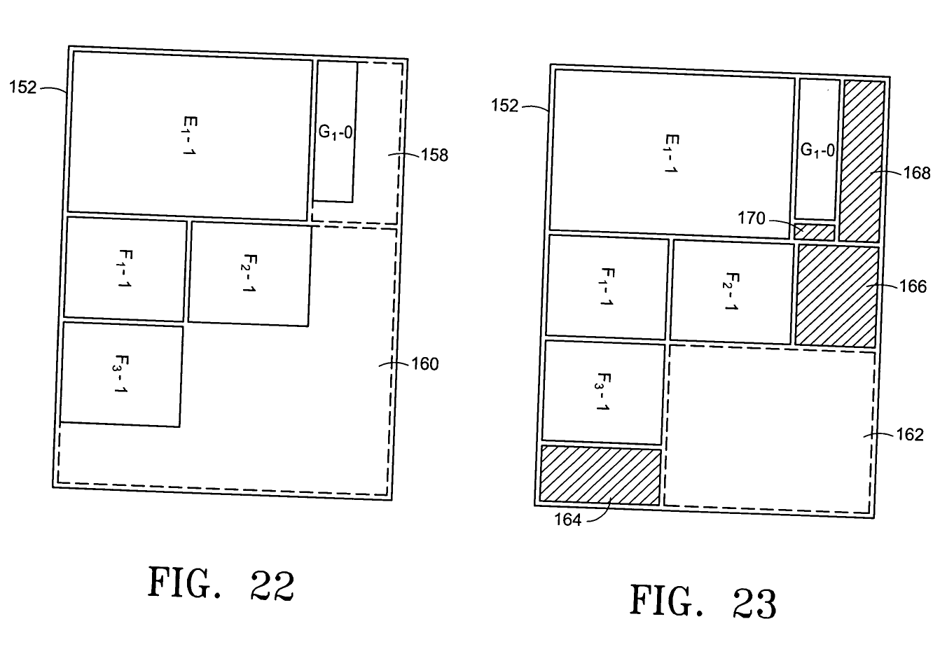

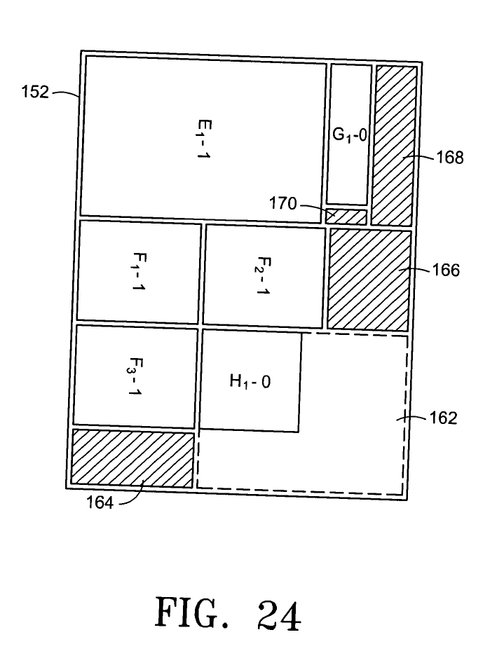

Step 136 involves determining if there is no packed space, if the packed space is rectangular or irregular. FIGS. 20 and 21 show a packed space, defined by digital image E₁, that is rectangular. FIGS. 22 and 23 show a packed space, defined by digital images F₁, F₂, and F₃, that is irregular. If it is determined that there is no previously defined packing area and thus no packed space, the entire page is defined as the packing area (step 138). If the packed space is rectangular, the process continues with step 140. If the packed space is irregular, the process continues with step 146.

Where the packed space in question has been identified as rectangular—horizontal, vertical, and diagonal unused spaces are identified (step 140). FIG. 20 helps illustrate. Page 152 includes rectangular packed space, defined by digital image E₁, and three unused spaces 154-158. Space 154 is a diagonal space—meaning that it is located diagonally from packed space 153. Space 156 is a vertical space—meaning that it is located vertically from packed space 153. Space 158 is a horizontal space—meaning that it is located horizontally from packed space 153. The modifiers “diagonal,” “vertical,” and “horizontal” as used in this document are relative. For example, rotating page 152 ninety degrees would make horizontal space 158 a vertical space and would make vertical space 156 a horizontal space. Diagonal space 156 would remain a diagonal space relative to horizontal space 158 and vertical space 156.

Referring back to FIG. 18, the diagonal space is combined with either the vertical space or the horizontal space to create a combined space with a maximized small dimension (step 142). FIG. 21 helps to illustrate. Here, diagonal space 154 (FIG. 20) has been combined with vertical space 156 (FIG. 20) to form combined space 160. Combined space 160 has a small dimension 161A that is larger than small dimension 161 B of horizontal space 158. Had diagonal space 154 been combined with horizontal space 158, the combined space would include small dimension 161 B. Referring back again to FIG. 18, two packing areas are defined (step 144). The combined space is defined as the first, and the remaining vertical or horizontal space is defined as the second.

Referring again to FIG. 18, where the packed space in question has been identified as irregular in step 136, the left over jagged space is maximized (step 146). A jagged space is an unused space with two edges that border an irregularly packed space. FIGS. 22 and 23 help illustrate. Referring first to FIG. 22, page 152 includes two packing areas 160 and 158. Digital images F₁, F₂, and F₃ have been packed in packing area 160 creating an irregular packed space. Digital image G₁ has been packed in packing area 158 creating a rectangular packed space. Referring now to FIG. 23, The rectangular packed space in the previously defined packing area 158 ultimately leaves two unused spaces 168-170 each defined as a packing area following steps 140-144 of FIG. 18.

The irregular packed space created by digital images F₁, F₂, and F₃ in the previously defined packing area 160 leaves three unused spaces 162-166. The unused spaces are jagged space 162, left over vertical space 164, and left over horizontal space 166. Jagged space 162, as shown, has been maximized. Referring back to FIG. 18, three packing areas are defined (step 148). The maximized jagged space is the first, followed by the left over vertical space and the left over horizontal space.

CONCLUSION: The diagrams of FIGS. 2A-C and 3 show the architecture, functionality, and operation of various embodiments of the present invention. A number of the blocks are defined as programs. Each of those blocks may represent in whole or in part a module, segment, or portion of code that comprises one or more executable instructions to implement the specified logical function(s). Each block may represent a circuit or a number of interconnected circuits to implement the specified logical function(s). The exemplary interface of FIG. 4 is just that, an example of one of many possible interfaces that can be used to select digital images.

Also, the present invention can be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, infrared, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 5-7 and 18 show specific orders of execution, the orders of execution may differ from that which is depicted. For example, the order of execution of two or more blocks may be scrambled relative to the order shown. Also, two or more blocks shown in succession may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention that is defined in the following claims.

What is claimed is:

1. A method for arranging digital images, comprising:
generating a first trial pack and a second trial pack, such that in the first trial pack the digital images are uniquely oriented as compared to the second trial pack;
comparing the trial packs; and
selecting one of the trial packs based on the comparison.

2. The method of claim 1, wherein comparing comprises identifying a trial pack that leaves the least unused space, and wherein selecting comprises selecting the identified trial pack.

3. A method for arranging digital images on a page, comprising:
defining a packing area;
if it will fit in the packing area, packing a digital image in the first orientation in a first trial pack; and
if it will fit in the packing area, packing the digital image in the second orientation in a second trial pack.

4. The method of claim 3, further comprising:
identifying a largest image size that will fit in the packing area; and
wherein packing the digital image in the first orientation includes, if a digital image of the identified size will fit in the first orientation, packing as many digital images of the identified size as possible in the first trial pack; and
wherein packing the digital image in the second orientation includes, if a digital image of the identified size will fit in the second orientation, packing as many digital images of the identified size as possible in the second trial pack.

5. The method of claim 4, wherein:
identifying a largest size, comprises identifying, from a set of digital images, a largest image size that will fit in the packing area; and
packing as many digital images of the identified size as possible comprises repeatedly packing digital images of the identified size in a given orientation until either another digital image of the identified size will not fit or no digital image of the identified size remains in the set.

6. A method for generating trial packs from a set of digital images, comprising
opening a trial pack as an empty page;
continuing, if possible, each open trial pack and closing each trial pack that cannot be continued; and
repeating the steps of continuing and closing until no trial pack remains open.

7. The method of claim 6, wherein continuing, comprises:
defining a packing area;
upon determining that at least one digital image from the set that has yet to be packed in the open trial pack will fit in the packing area;
identifying a largest size of a digital image remaining in the set that will fit in the packing area;
if it will fit, packing a digital image of the identified size in a first orientation and continuing the open trial pack as a first child trial pack; and
if it will fit, packing a digital image of the identified size in a second orientation and continuing the trial pack as a second child trial pack.

8. The method of claim 7, wherein:
packing the identified digital image in the first orientation comprises packing as many digital images of the identified size as possible in the first orientation and continuing the open trial pack as a first child trial pack; and
packing the identified digital image in the second orientation comprises packing as many digital images of the identified size as possible in the second orientation and continuing the open trial pack as a second child trial pack.

9. The method of claim 8, wherein packing as many digital images of the identified size as possible comprises repeatedly packing digital images of the identified size in a given orientation until either another digital image of the identified size will not fit or no digital image of the identified size remains in the set.

10. The method of claim 7, wherein closing comprises, for each open trial pack, closing that pack if no digital image from the set that has yet to be packed in the open trial pack will fit in the packing area.

11. A method for arranging a set of digital images on a page, comprising:
selecting a set of digital images;
generating trial packs for the selected set of digital images;
comparing the trial packs;
selecting a trial pack based upon the comparison; and
determining if any of the digital images from the set were not used in the selected trial pack, and if any digital images are determined to not be used, selecting the unused digital images as the set of digital images and repeating the steps of generating, comparing, selecting, and determining.

12. The method of claim 11, wherein generating trial packs comprises:
opening a trial pack as an empty page;
continuing, if possible, each open trial pack and closing each trial pack that cannot be continued; and
repeating the steps of continuing and closing until no trial pack remains open.

13. The method of claim 12, wherein comparing comprises comparing closed trial packs.

14. The method of claim 12, wherein continuing, comprises:
defining a packing area;
upon determining that at least one digital image from the set that has yet to be packed in the open trial pack will fit in the packing area;
identifying a largest size of a digital image remaining in the set that will fit in the packing area;
if it will fit, packing a digital image of the identified size in a first orientation and continuing the open trial pack as a first child trial pack; and
if it will fit, packing a digital image of the identified size in a second orientation and continuing the trial pack as a second child trial pack.

15. The method of claim 14, wherein:
packing the identified digital image in the first orientation comprises packing as many digital images of the identified size as possible in the first orientation and continuing the open trial pack as a first child trial pack; and
packing the identified digital image in the second orientation comprises packing as many digital images of the identified size as possible in the second orientation and continuing the open trial pack as a second child trial pack.

16. The method of claim 15, wherein packing as many digital images of the identified size as possible comprises repeatedly packing digital images of the identified size in a given orientation until either another digital image of the identified size will not fit or no digital image of the identified size remains in the set.

17. The method of claim 14, wherein closing comprises, for each open trial pack, closing that pack if no digital image from the set that has yet to be packed in the open trial pack will fit in the packing area.

18. The method of claim 14, wherein defining a packing area comprises identifying a geometry of a packed space and defining a packing area according the geometry of the packed space.

19. The method of claim 14, wherein defining a packing area comprises identifying a packed space as rectangular, identifying left over spaces located diagonally, vertically, and horizontally relative to the packed space, combining the diagonal space with either the vertical space or the horizontal space creating a combined space having a maximized small dimension, and defining a first packing area as the combined space and defining a second packing area as the remaining horizontal or vertical space.

20. The method of claim 14, wherein identifying a packing area comprises identifying a packed space as irregular, maximizing a jagged space, identifying remaining spaces that are located vertically and horizontally relative to the packed space, defining a first packing area as the maximized jagged space, defining a second packing area as the left over vertical space, and defining a third packing are as the left over horizontal space.

21. A computer readable medium having instructions for:
generating a first trial pack and a second trial pack, such that in the first trial pack digital images are uniquely oriented as compared to the second trial pack;
comparing the trial packs; and
selecting one of the trial packs based on the comparison.

22. The medium of claim 21, wherein the instructions for comparing include instructions for identifying a trial pack that leaves the least unused space, and wherein the instructions for selecting include instructions for selecting the identified trial pack.

23. A computer readable medium having instructions for:
defining a packing area;
if it will fit in the packing area, packing a digital image in the first orientation in a first trial pack; and
if it will fit in the packing area, packing the digital image in the second orientation in a second trial pack.

24. The medium of claim 23, having further instruction for:
identifying a largest image size that will fit in the packing area; and
wherein the instructions for packing the digital image in the first orientation include instructions for, if a digital image of the identified size will fit in the first orientation, packing as many digital images of the identified size as possible in the first trial pack; and
wherein the instructions for packing the digital image in the second orientation include instructions for, if a digital image of the identified size will fit in the second orientation, packing as many digital images of the identified size as possible in the second trial pack.

25. The medium of claim 24, wherein the instructions for:
identifying a largest size, comprises identifying, from a set of digital images, a largest image size that will fit in the packing area; and
packing as many digital images of the identified size as possible comprises repeatedly packing digital images of the identified size in a given orientation until either another digital image of the identified size will not fit or no digital image of the identified size remains in the set.

26. A computer readable medium having instructions for:
selecting a set of digital images;
opening a trial pack as an empty page;
continuing, if possible, each open trial pack and closing each trial pack that cannot be continued; and
repeating the instructions for continuing and closing until no trial pack remains open.

27. The medium of claim 26, wherein the instructions for continuing, include instructions for:
defining a packing area;
upon determining that at least one digital image from the set that has yet to be packed in the open trial pack will fit in the packing area;
identifying a largest size of a digital image remaining in the set that will fit in the packing area;
if it will fit, packing a digital image of the identified size in a first orientation and continuing the open trial pack as a first child trial pack; and
if it will fit, packing a digital image of the identified size in a second orientation and continuing the trial pack as a second child trial pack.

28. The medium of claim 27, wherein the instructions for:
packing the identified digital image in the first orientation include instructions for packing as many digital images of the identified size as possible in the first orientation and continuing the open trial pack as a first child trial pack; and
packing the identified digital image in the second orientation include instructions for packing as many digital images of the identified size as possible in the second orientation and continuing the open trial pack as a second child trial pack.

29. The medium of claim 28, wherein the instructions for packing as many digital images of the identified size as possible include instructions for repeatedly packing digital images of the identified size in a given orientation until either another digital image of the identified size will not fit or no digital image of the identified size remains in the set.

30. The medium of claim 27, wherein the instructions for closing include instructions for, for each open trial pack, closing that pack if no digital image from the set that has yet to be packed in the open trial pack will fit in the packing area.

31. A computer readable medium having instructions for
selecting a set of digital images;
generating trial packs for the selected set of digital images;
comparing the trial packs;
selecting a trial pack based upon the comparison; and
determining if any of the digital images from the set were not used in the selected trial pack, and if any digital images are determined to not be used, selecting the unused digital images as the set of digital images and repeating the steps of generating, comparing, selecting, and determining.

32. The medium of claim 31, wherein the instructions for generating trial packs include instructions for:
opening a trial pack as an empty page;
continuing, if possible, each open trial pack closing each trial pack that cannot be continued; and
repeating the instruction for continuing and closing until no trial pack remains open.

33. The medium of claim 32, wherein the instructions for comparing include instructions for comparing closed trial packs.

34. The medium of claim 32, wherein the instructions for continuing, include instructions for:
defining a packing area;
upon determining that at least one digital image from the set that has yet to be packed in the open trial pack will fit in the packing area;
identifying a largest size of a digital image remaining in the set that will fit in the packing area;
if it will fit, packing a digital image of the identified size in a first orientation and continuing the open trial pack as a first child trial pack; and
if it will fit, packing a digital image of the identified size in a second orientation and continuing the trial pack as a second child trial pack.

35. The medium of claim 34, wherein:
the instructions for packing the identified digital image in the first orientation include instructions for packing as many digital images of the identified size as possible in the first orientation and continuing the open trial pack as a first child trial pack; and
the instructions for packing the identified digital image in the second orientation include instructions for packing as many digital images of the identified size as possible in the second orientation and continuing the open trial pack as a second child trial pack.

36. The medium of claim 35, wherein the instructions for packing as many digital images of the identified size as possible include instructions for repeatedly packing digital images of the identified size in a given orientation until either another digital image of the identified size will not fit or no digital image of the identified size remains in the set.

37. The medium of claim 34, wherein the instructions for closing include instructions for, for each open trial pack, closing that pack if no digital image from the set that has yet to be packed in the open trial pack will fit in the packing area.

38. The medium of claim 34, wherein the instructions for defining a packing area include instructions for identifying a geometry of a packed space and defining a packing area according the geometry of the packed space.

39. The medium of claim 34, wherein the instructions for defining a packing area include instructions for identifying a packed space as rectangular, identifying left over spaces located diagonally, vertically, and horizontally relative to the packed space, combining the diagonal space with either the vertical space or the horizontal space creating a combined space a maximized small dimension, and defining a first packing area as the combined space and defining a second packing area as the remaining horizontal or vertical space.

40. The medium of claim 34, wherein the instructions for defining a packing area include instructions for identifying a packed space as irregular, maximizing a jagged space, identifying remaining spaces that are located vertically and horizontally relative to the packed space, defining a first packing area as the maximized jagged space, defining a second packing area as the left over vertical space, and defining a third packing are as the left over horizontal space.

41. A packing module for arranging digital images, comprising:
a trial pack generator operable to generate a first trial pack and a second trial pack, such that digital images in the first trial pack are uniquely oriented as compared to digital images in the second trial pack; and
a pack selector operable to compare the trial packs and select one of the trial packs based on the comparison.

42. The packing module of claim 41, wherein the pack selector is operable to identify a trial pack that leaves the least unused space and to select the identified trial pack.

43. A system for arranging a set of digital images, comprising a
a trial pack generator operable to generate trial packs for the set of digital images;
a pack selector operable to compare generated trial packs generated by the trial pack generator, to select a trial pack based upon the comparison; and,
until all digital image from the set are used in one of one or more selected trial packs, to direct the trial pack generator to generate new trial packs for any digital images not used in a selected trial pack.

44. The system of claim 43, wherein the trial pack generator includes:
a packing area selector operable to define a packing area;
a packager operable to open a trial pack as an empty page and, using packing areas defined by the packing area selector, to repeatedly continue, if possible, each open trial pack and to close each open trial pack that cannot be continued until no trial pack remains open.

45. The system of claim 44, wherein:
the pack generator includes a coordinator operable to identify from the set a largest size of a digital image remaining in the set that will fit in a space identified by the packing area selector; and
the packager is operable to continue an open trial pack by;
if it will fit, packing a digital image of the identified size in a first orientation in an packing area and continuing the open trial pack as a first child trial pack; and
if it will fit, packing a digital image of the identified size in a second orientation and continuing the trial pack as a second child trial pack.

46. The system of claim 44, wherein the packager is operable to, for each open trial pack, close that trial pack if no digital image from the set that has yet to be packed in the open trial pack will fit in the packing area.

47. The system of claim 44, wherein the pack selector is operable to, once all open trial packs have been closed, compare the closed trial packs and select one of the closed trial packs based on the comparison.

48. A packing module for arranging digital images, comprising:
a means for generating a first trial pack;
a means for generating a second trial pack, such that digital images in the second trial pack are uniquely oriented as compared to digital images in the first trial pack;
a means for comparing the trial packs; and
a means for selecting one of the trial packs based on the comparison.
